(19) United States
(12) Patent Application Publication
(10) Pub. No.: US 2018/0350198 A1
(43) Pub. Date: Dec. 6, 2018

(54) ENTERTAINMENT SYSTEM INVOLVING BLACKJACK

(71) Applicant: Chi Fat Au-Yeung, Birmingham (GB)

(72) Inventor: Chi Fat Au-Yeung, Birmingham (GB)

(21) Appl. No.: 15/613,214

(22) Filed: Jun. 4, 2017

(51) Int. Cl. G07F 17/32; A63F 1/00; A63F 1/06

(52) U.S. Cl. CPC G07F 17/3293; A63F 1/00; A63F 2001/003; G07F 17/3276; G07F 17/3248; A63F 1/067

(57) ABSTRACT

A method, system, and computer readable storage to implement an entertainment system which can be used for wagering. Players at the same table first each make a wager. A common hand is maintained which is shared by a plurality of players. Players can then play out their common hand individually, with each player's point total being marked on a betting area for each player. Then, after all players have completed their hand, the dealer would complete his/her hand and the wagers can then be resolved.

### BACKGROUND OF THE INVENTION

### Field of the Invention

The present general inventive concept is directed to a method, apparatus, and computer readable storage medium directed to a wagering game.

### Description of the Related Art

Casino games (both played in live format and electronic format) are a billion dollar industry. The industry is also striving to produce new and exciting wagering methods which players may find fresh and exciting and the house (casino) finds profitable.

### SUMMARY OF THE INVENTION

It is an aspect of the present invention to provide an exciting casino system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a blackjack variation, according to an embodiment;

FIG. 2 is a further flowchart illustrating the exemplary method of implementing a blackjack variation, according to an embodiment;

FIG. 3 is a drawing illustrating a table layout, according to an embodiment;

FIG. 4A is a block diagram illustrating exemplary hardware that can be used to implement an electronic version of the methods described herein; and

FIG. 4B is a block diagram illustrating an exemplary network configuration to implement a player playing an online version of the methods described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The game of blackjack is described in U.S. patent publication 2003/0155715 which is incorporated by reference herein in their entireties. The game can be played with any number (e.g., 1-8) of standard 52 card decks.

The inventive concept relates to a blackjack variation in which all of the players at the table use a common hand instead of being dealt their own hands/cards. The dealer is dealt his/her own separate hand as well.

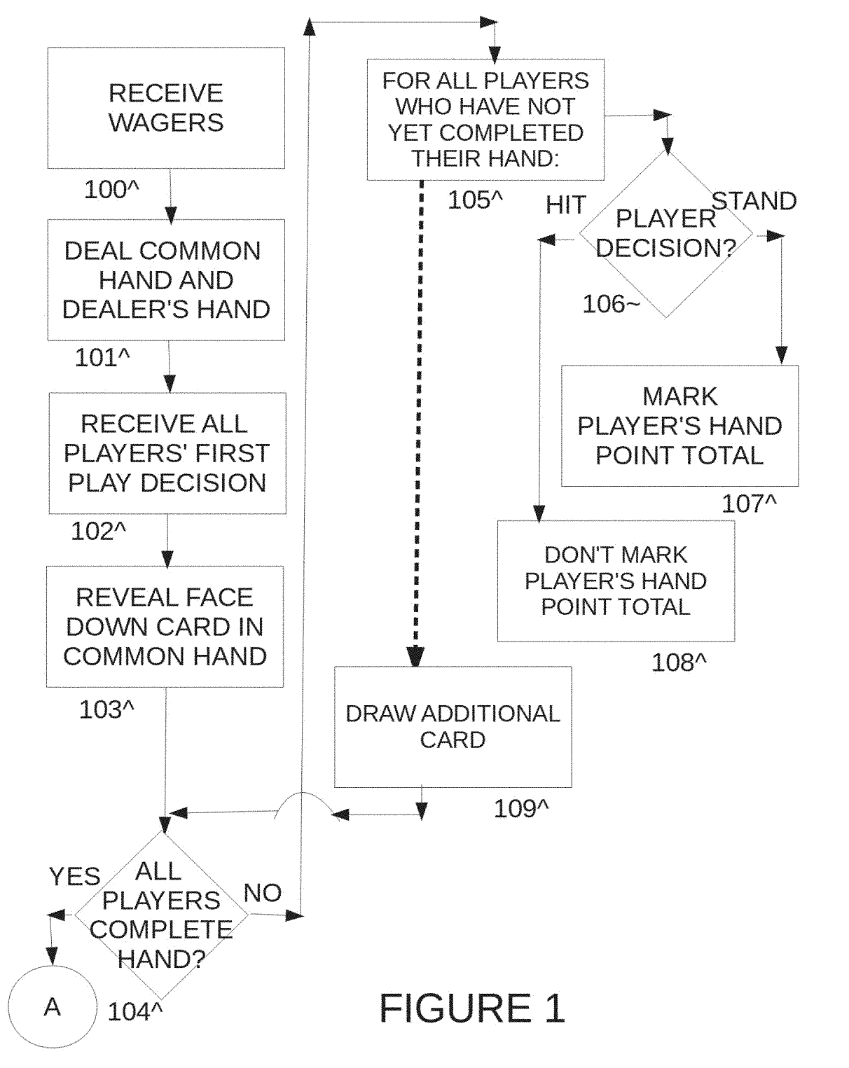

FIG. 1 is a flowchart illustrating an exemplary method of implementing a blackjack variation, according to an embodiment.

The method can begin with operation 100 which receives wagers from all of the players at the table. The wagers comprise main wagers (mandatory) which are resolved based on the outcome of the main blackjack game and side wagers (optional). This can be done as known in the art, for example, placing chips (redeemable for cash at a casino cashier) on a betting circle on the table.

From operation 100, the method proceeds to operation 101, wherein the dealer deals a common hand on the table comprising two face up cards and one face down card. In an embodiment when the two face up cards in the common hand are a pair of As, 2s, 3s, 6s, 7s or 8s then the second card is replaced until a different rank is dealt, and the player may draw to an ace with a replaced card (but there is no splitting). In a further embodiment there is splitting, such that if the two face up cards in the common hand are a pair of As, 2s, 3s, 6, 7s, or 8s, then the first two cards will be split into two separate hands and players must play the first hand with an option of playing the second hand by making a second wager equal to their original main wager, on the second split hand. In a further embodiment, In a further embodiment, when the two face up cards in the common hand are a pair of 4-4, 5-5, 9-9, or a 2-card 20, then the two face cards in the common hand must stay together as one hand and cannot separate into 2 new hands and thus players must either stand, hit, or double down. The dealer also deals a dealer's hand comprising one face up card (the dealer's “upcard”) and two face down cards.

From operation 101, the method proceeds to operation 102, which receives all of the players first play decisions. After each player sees the two face up cards in the common hand (this is the player's initial hand) each player can make their first decision of the game. The decisions comprises whether to stand, hit, or double. Note that there is no splitting. If the player chooses to stand then the point total that the player stands on is marked. Each player has a betting layout in front of them which comprises the betting circles and areas for the following point totals: 16, 17, 18, 19, 20, 21. A lammer (marker) is placed on the point total in which the player chooses to stand on. Alternatively, the dealer can move the player's main wager (chips) onto the point total in which the player chooses to stand on. In this way, it signifies that the player has completed his/her hand and also sets forth what the total of the player's hand is. Any point total under 17 would be marked as 16. Players can double down by placing another wager of equal value to the main wager alongside the main wager. Players can hit by indicating to the dealer they wish to hit upon which no marking of the player betting area is necessary (if there are no double down chips and there is no point total marked then it can be concluded the player wished to hit).

In operation 102, each player at the table has a chance to select a strategy. Then the method proceeds to operation 103.

From operation 102, the method proceeds to operation 103, which reveals the face down card in the common hand. For all players who have hit or doubled and the player's point total (the point total of all of the three cards in the common hand) are over 21 (hard 21) then the player has “busted” and automatically loses his/her main wager which is taken by the house. Thus, all betting areas which do not have a main wager present can be assumed that the respective player has busted.

For players who have chosen to double, the respective point total in the player's betting area is marked (e.g., by using a lammer or moving one or both stacks of player chips to the respective point total).

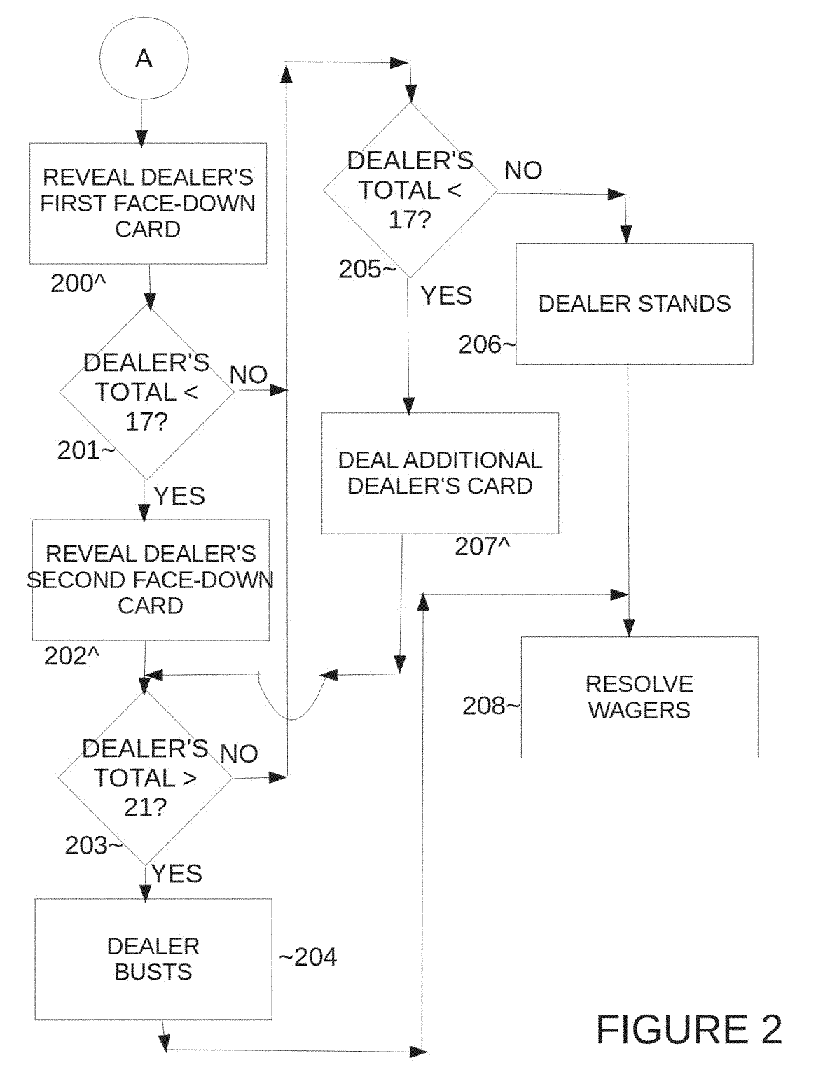

From operation 103, the method proceeds to operation 104, which determines whether all players have completed their hand yet. This can be done by looking at each player's betting area and determining if any player chose hit. If any player chose to hit, then the method proceeds to operation 105. If all players chose to stand or double or has busted, then the method proceeds to connector A which continues into FIG. 2.

If in operation 105, there is at least one player that may still need to draw another card. For all players that have not completed their hand (either standed, doubled) then operations 106 to 108 are performed for each of those players. Note that if any player has busted than that means the common hand has busted and no further cards need to be dealt (i.e., all players would have completed their hand). In operation 108, the respective player decides whether to stand or hit. If the player decides to stand, then the method proceeds to operation 107 which marks the current point total (all three common cards plus any other card dealt to the common hand). If in operation 106, the player decides to hit, then the player's betting area is not marked (e.g., no chips or lammer is placed at any of the point totals on the player's area). After all players who have not yet completed their hand have performed operations 106 (and follow up operation 107 or 108), then the method proceeds to operation 108 to operation 109.

In operation 109, the dealer draws (deals) an additional card face up to the common area. This card is now added to the player's (common hand) point total. For all players who have hit during the most recent time operation 106 has been implemented, and the player's point total (the point total of all of the cards in the common hand) is over 21 (hard 21) then these player(s) have “busted” and automatically lose their main wager which is taken by the house. Thus, all betting areas which do not have a main wager present can be assumed that the respective player has busted.

From operation 109, the method proceeds to operation 104. If all players have completed their hand (there is no player that does not have a point total marked on his betting area), then the method proceeds to connector A.

If in operation 104, if there is at least one player that has not yet completed their hand (i.e. at least one player that does not have a point total marked on his/her betting area), then the method proceeds to operation 105.

This flow can loop (from operation 104 to operation 105 (with operation 106 and 107/108 being performed for each player who has not yet completed their hand) and then back to operation 104) until all players have completed their hand. When all players have completed their hand, the method proceeds to connector A (see FIG. 2).

FIG. 2 is a further flowchart illustrating the exemplary method of implementing a blackjack variation, according to an embodiment.

After all of the players have completed their hand, it is time now for the dealer to complete his/her hand and then resolve the wagers.

In operation 200, the dealer's first face-down (the “hole card”) is revealed (turned face up). The dealer's total (also referred to as dealer's point total) is the sum of the values of both dealer's revealed cards.

From operation 200, the method proceeds to operation 201, which determines whether the dealer's total is less than 17 (a predetermined point total). In other words, the dealer will stand on all point totals over 16 and hit an all point totals less than 17.

If in operation 201 the dealer's point total is not less than 17, then the method proceeds to operation 206 wherein the dealer stands.

If in operation 201 the dealer's point total is less than 17, then the method proceeds to operation 202, which reveals the dealer's second face-down card (this can be considered a dealer's first draw card). The dealer's point total is now computed by adding up the values of all three cards.

From operation 202, the method proceeds to operation 203, which determines whether the dealer's total is over 21. If the dealer's point total is over 21 then the dealer busts and the method proceeds to operation 204. From operation 204, the method proceeds to operation 208 which resolves all of the wagers.

If in operation 203, the dealer's point total is not greater than 21, then the method proceeds to operation 205, which determines whether the dealer's point total is less than 17. If the dealer's point total is not less than 17, then the method proceeds to operation 206 in which the dealer stands and the method proceeds to operation 208.

If in operation 205 it is determined that the dealer's total is less than 17, then the method proceeds to operation 207, which deals an additional dealer's card face up to the dealer's hand. From operation 207, the method proceeds to operation 203.

In this manner, the dealer's hand is resolved by drawing additional cards when necessary until the dealer's hand is over 21 (dealer busts) or the dealer's hand is over 17 (but not a bust) in which the dealer has made a hand.

In operation 208, the wagers are all resolved. The main wagers are resolved based upon predetermined rules. For example, if the player busted then the player should lose their main wager (which should have already been taken by the house). If the player did not bust but the dealer busted then the player would win even money on the main wager. If both the player and the dealer did not bust, then the highest hand wins (if the dealer has the higher hand then the player loses his/her main wager, and if the player has the higher hand then the player wins even money on the main wager). If the player's point total and the dealer's point total tie, then this can be considered a push and the player's main wager neither wins nor loses.

All side bets can be resolved at this point as well (which would have been made in operation 100). A first side bet can be resolved based on the two initial player's cards (the two common cards dealt face up). Table I below illustrates a sample paytable for this side bet.

TABLE I

| Hand | payout |
|---|---|
| Pair of 5's | 22 to 1 |
| Any other hand totaling 10 | 10 to 1 |
| Hand total of 20 (including A-9) | 3 to 1 |
| All others | lose (−1) |

In another embodiment, a side bet can also be placed on the two initial player's cards (the two common cards dealt face up). Table II below illustrates a sample paytable for this side bet. “PT” stands for paytable, Table II shows various possible paytables that can be used.

TABLE II

| Hand | PT 1 | PT 2 | PT 3 | PT 4 | PT 5 | PT 6 |
|---|---|---|---|---|---|---|
| Suited: 5/6, 4/7, 3/8, 2/9 | 21 | 19 | 18 | 13 | 12 | 22 |
| Off-suit 5/6, 4/7, 3/8, 2/9 | 10 | 11 | 11 | 13 | 12 | 10 |
| Blackjack | 5 | 5 | 5 | 5 | 6 | 5 |
| All others | −1 | −1 | −1 | −1 | −1 | −1 |

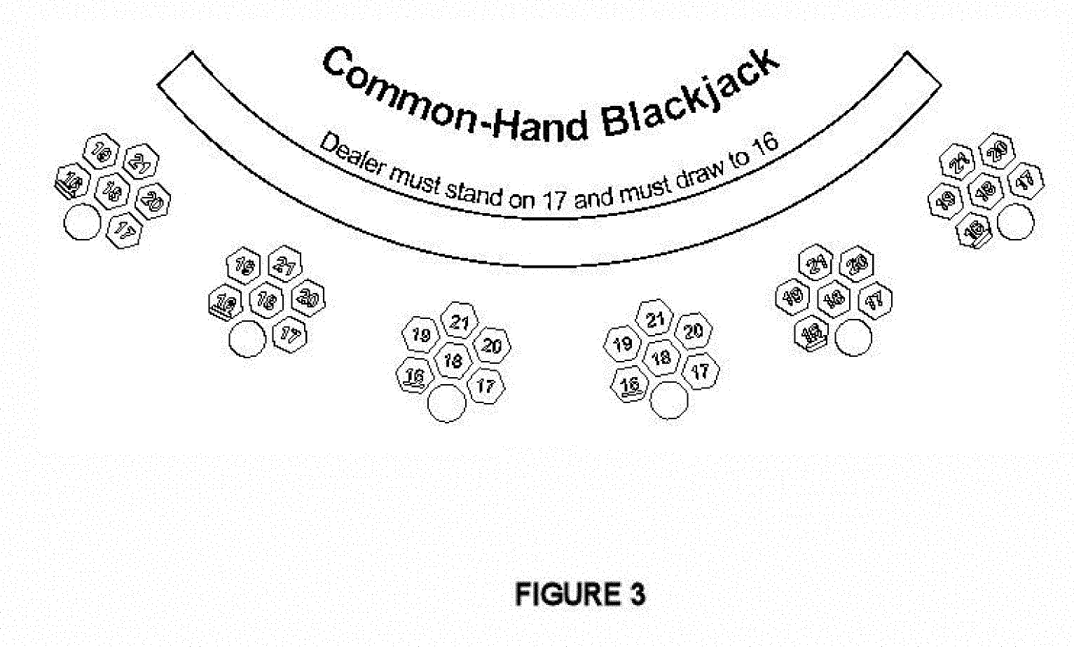

FIG. 3 is a drawing illustrating a table layout, according to an embodiment.

The table layout allows for six simultaneous players, although a table can accommodate any number of such players. Each betting area has a set of areas with various point totals (16, 17, 18, 19, 20, 21) and a betting circle for the main wager. The ‘16’ point total (area) is used to mark when the player stands with a point total (i.e., the point total of the common hand) is under 17 (all such hands are effectively the same in blackjack since they only win if the dealer busts). When a player stands the respective point total is marked (with a marker or the player's chips on the betting circle for the main wager are moved (typically by the dealer) to the proper point total area. When the player busts (e.g., chooses to hit and then a common hand draw card is dealt which causes the player total (i.e., the common hand total) to exceed 21, then the player's main wager is taken (this is how one can ascertain that the player has busted later on in the game while other players have standed and thus alive in the game awaiting the completion of the dealer's hand). If the player has not yet standed or busted, none of the point totals are marked on the respective player's betting area so it can be ascertained that this player still has not yet completed his/her hand.

An example of the game will now be presented. The cards dealt in this example are random and of course, any other cards can be dealt. A table has three players: Stephen, Jon, and Wilma. Stephen, Jon, and Wilma each bet $1 for the main wager (no side wagers are placed). The dealer then deals three cards in the common area, two face up: Ace-spades/seven-hearts, and a face down card. The dealer also deals three cards in the dealer area, one face up: nine-hearts, and two face down. Wilma indicates to the dealer she wishes to stand and her $1 chip is placed on the 18 point total in her betting area (Wilma has now completed her hand). Stephen decides to double and places another $1 chip alongside the initial $1 main wager. Jon decides to hit with no marking needed on the betting area. Since all players have either completed their hand (Wilma) or indicated their strategy (Stephen, Jon), then the dealer turns over the common face down card, to reveal a four-clubs. Now the player's total is 12. Since Wilma standed and Stephen doubled (and cannot draw another card), only Jon has the option to choose between hit and stand. Jon decides to hit. The dealer then deals a new card into the common area, a 10-spades. Jon has busted and his main wager is taken. Now that all players have completed their hand, the dealer now turns over one of the dealer's face down cards to reveal a 5-clubs, for a dealer total of 14. The dealer then turns over the second face down card to reveal an ace-spades, for a dealer total of 15. The dealer then deals a new card to the dealer area which happens to be a 2-diamonds, for a total of 17. The dealer now stands. All of the live players (Stephen, Wilma) have their wagers resolved while Jon is not live (since he busted). Stephen has a point total of 12 and so he loses his main wager. Wilma has a point total of 18 which is higher than the dealer's point total of 17, so Wilma wins an even money payout ($1) on her main wager. The game is now over.

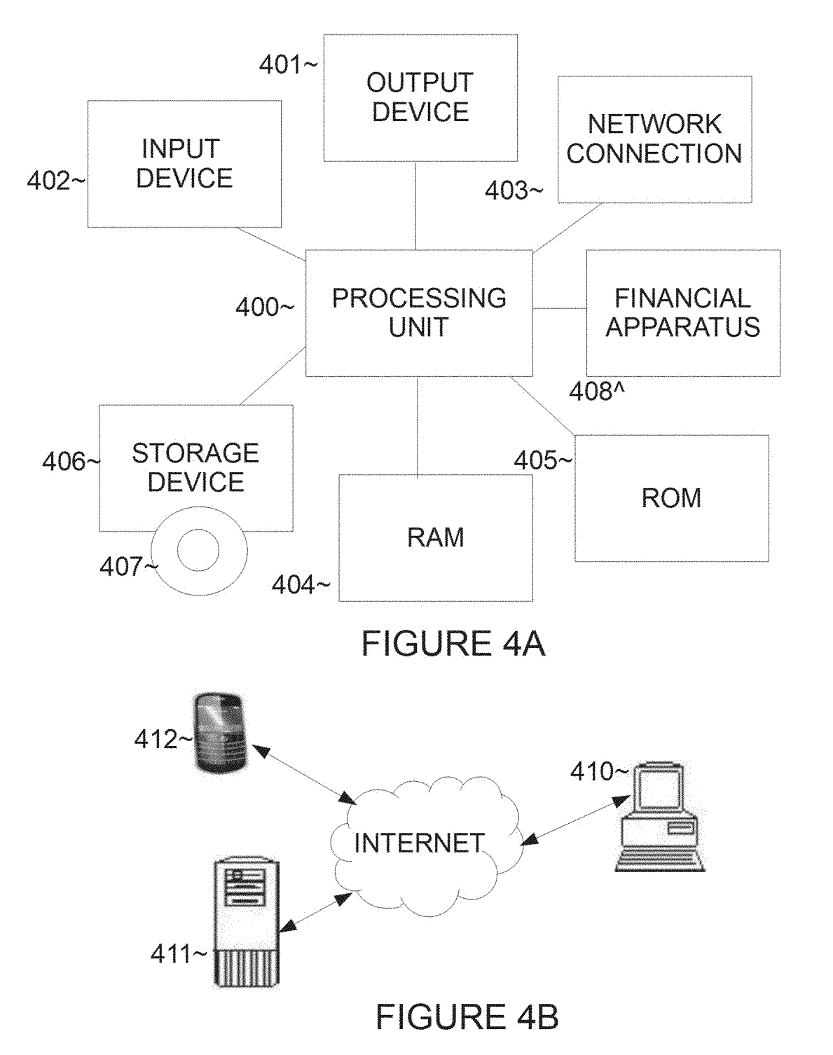

FIG. 4A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 400 (such as a microprocessor and any associated components) is connected to an output device 401 (such as an LCD monitor, touch screen, CRT, etc.) which is used to display to the player any aspect of the method, and an input device 402 (e.g., buttons, a touch screen, a keyboard, mouse, etc.) which can be used to input from the player any decision made by the player. All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, etc. Multiple such processing units can also work in collaboration with each other (in a same or different physical location). A non-transitory computer readable storage medium 407 can store a program which can control the electronic device to perform any of the methods described herein and can be read by the storage device 406. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 4B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 410 (e.g., cell phone, tablet, PC, etc.) can connect to a server 411 (which can have the structure illustrated in FIG. 4A) using a computer communications network such as the Internet. The server 411 hosts an online casino which determines the outcomes of the game and serves the outcomes to the computer 410 so the computer 410 displays the outcomes to the player. Other users can also play at the online casino hosted by the server 411 simultaneously, such as using a cell phone 412 with wireless internet connectivity. Any number of players (e.g., 1 to 100 or more than 100) can be connected to the internet and can play simultaneously on the sever 411 even though these players are all located in different physical locations. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. All features in all documents incorporated by reference herein can be combined with any feature(s) described herein, and also with all other features in all other documents incorporated by reference, without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method for implementing a wagering game, the method comprising:
providing a blackjack table, wherein the table has a plurality of betting areas, each betting area comprises indicia which has numbers from 16-21;
receiving a plurality of main wagers, wherein each of a plurality of players places one of the plurality of main wagers;
dealing a common hand in a common area comprising at least two face-up cards;
dealing a dealer's hand comprising at least an up-card;
a) enabling all player(s) who have not completed their hand to choose an initial action comprising hit, stand, wherein player(s) who stand have a respective point total marked in their respective betting area;
b) drawing or revealing, if a new card is needed by one or more players, or revealing a new card to the common area;
repeating operations a and b until all players have completed their hand;
completing the dealer's hand; and
resolving each of the plurality of main wagers based on predetermined rules,
wherein the respective point total marked in each player's respective betting area is marked by moving the respective player's main wager into a respective number corresponding to the respective point total.

2. The method as recited in claim 1, wherein the players are not allowed to split their hand.

3. The method as recited in claim 1, wherein the players are allowed to double their main wager on their first action.

4. The method as recited in claim 1, wherein the dealing the common hand also comprises dealing a face-down card.

5. The method as recited in claim 1, wherein the dealing the dealer's hand also comprises dealing at least one face-down dealer's card.

6. The method as recited in claim 1, wherein the dealing the dealer's hand also comprises dealing at least two face-down dealer's cards.

7. (canceled)

8. The method as recited in claim 1, wherein the respective point total is marked as a 16 when the respective point total is any total under 17.

9. The method as recited in claim 1, wherein a predetermined splitting rule comprises if an initial two cards of the common hand comprise a pair of aces, 2's, 3's 6's, 7's, or 8's, then the player must split the pair.

10. The method as recited in claim 9, wherein a further predetermined splitting rule comprises that players are not allowed to split pairs of 4's, 5's, 9's, or two-card point total totaling 20.
